(19) United States
(12) Patent Application Publication
(10) Pub. No.: US 2016/0072966 A1
(43) Pub. Date: Mar. 10, 2016

(54) NON-TRANSITORY COMPUTER READABLE MEDIUM AND IMAGE PROCESSING DEVICE

(71) Applicant: FUJI XEROX CO., LTD., Tokyo (JP)

(72) Inventor: Toshiaki KOUE, Yokohama-shi (JP)

(21) Appl. No.: 14/638,725

(22) Filed: Mar. 4, 2015

(30) Foreign Application Priority Data
Sep. 9, 2014 (JP) 2014-182926
Sep. 17, 2014 (JP) 2014-188862

(51) Int. Cl. H04N 1/00

(52) U.S. Cl. CPC H04N 1/0044; H04N 1/00493; H04N 1/00209

(57) ABSTRACT

An image processing device includes a preview unit that displays a specific page on a basis of a feature amount of an image of each page of document image information generated by optically scanning a document with an optical scanning unit.

### CROSS-REFERENCE TO RELATED APPLICATIONS

This application is based on and claims priority under 35 USC 119 from Japanese Patent Application No. 2014-182926 filed on Sep. 9, 2014 and Japanese Patent Application No. 2014-188862 filed on Sep. 17, 2014.

### BACKGROUND

1. Technical Field

The present invention relates to a non-transitory computer readable medium, and an image processing device.

2. Related Art

In the related art, it is suggested that an image forming device displays a read image as a preview image when a blank page is present in the read image.

### SUMMARY

An aspect of the present invention provides a non-transitory computer readable medium storing a program causing a computer to execute a process for image processing, the process including: displaying in a preview manner a specific page on a basis of a feature amount of an image of each page of document image information generated by optically scanning a document with an optical scanning unit.

### BRIEF DESCRIPTION OF THE DRAWINGS

Exemplary embodiment(s) of the present invention will be described in detail based on the following figures, wherein

FIG. 1 is a schematic diagram showing a configuration example of a communication system according to Embodiment 1 of the present invention;

FIG. 2 is a block diagram showing a configuration example of an image forming device;

FIG. 3 is a schematic diagram showing a configuration example of a preview display screen displayed on a display unit by a document image preview unit;

FIG. 4 is a flowchart showing an operation example of the image processing device;

FIG. 5 is a schematic diagram showing a configuration example of a communication system according to Embodiment 2 of the present invention;

FIG. 6 is a block diagram showing a configuration example of an image processing device;

FIG. 7 is a schematic diagram showing a configuration example of a preview display screen displayed on a display unit by a document image preview unit;

FIG. 8 is a schematic diagram showing an example of the configuration of communication result information;

FIG. 9 is a flowchart showing an operation example of the image processing device; and

FIG. 10 is a schematic diagram showing another example of the configuration of a preview display screen displayed on a display unit by a document image preview unit.

### DETAILED DESCRIPTION

### Embodiment 1

Configuration of Communication System

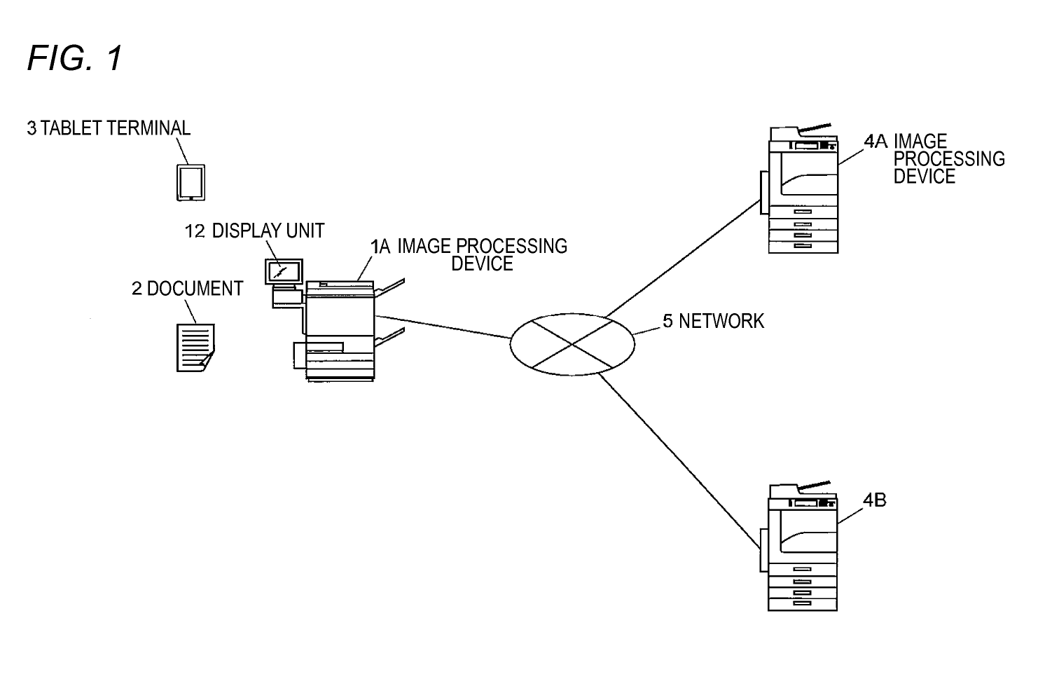

FIG. 1 is a schematic diagram showing a configuration example of a communication system according to Embodiment 1 of the present invention.

In this communication system, an image processing device 1A, and external image processing devices 4A and 4B through, for example, a network 5 which is a public network are connected so as to communicate with each other, and information is transmitted and received between the image processing device 1A and the external image processing devices 4A and 4B in, for example, a facsimile (hereinafter, referred to as a “FAX”) manner.

The image processing device 1A is a device having a FAX transmission and reception function and functions of a printer, a scanner and a copier, and includes electronic components such as a central processing unit (CPU) having a function of processing information and a flash memory. The image processing device 1A reads a document 2 in an optical scanning unit 14, displays a read result on a display unit 12, and performs FAX transmission in a FAX communication unit 16.

A tablet terminal 3 communicates with the image processing device 1A in, for example, a wireless manner, and controls the image processing device 1A such that the image processing device 1A displays the read result of the document 2 read in the optical scanning unit 14 and transmits an image of the read document 2 through the FAX transmission.

The image processing devices 4A and 4B may have the FAX transmission and reception function. The image processing devices may receive information transmitted from the image processing device 1A in order to print or display the received information, and may be, for example, a printer, or a PC, a tablet terminal or a mobile phone that receives information transmitted from the image processing device 1A in order to display the received information.

The network 5 is, for example, a pay communication network set up by a telecommunication carrier, and is an external network such as a public switched telephone network (PSTN) or an IP communication network.

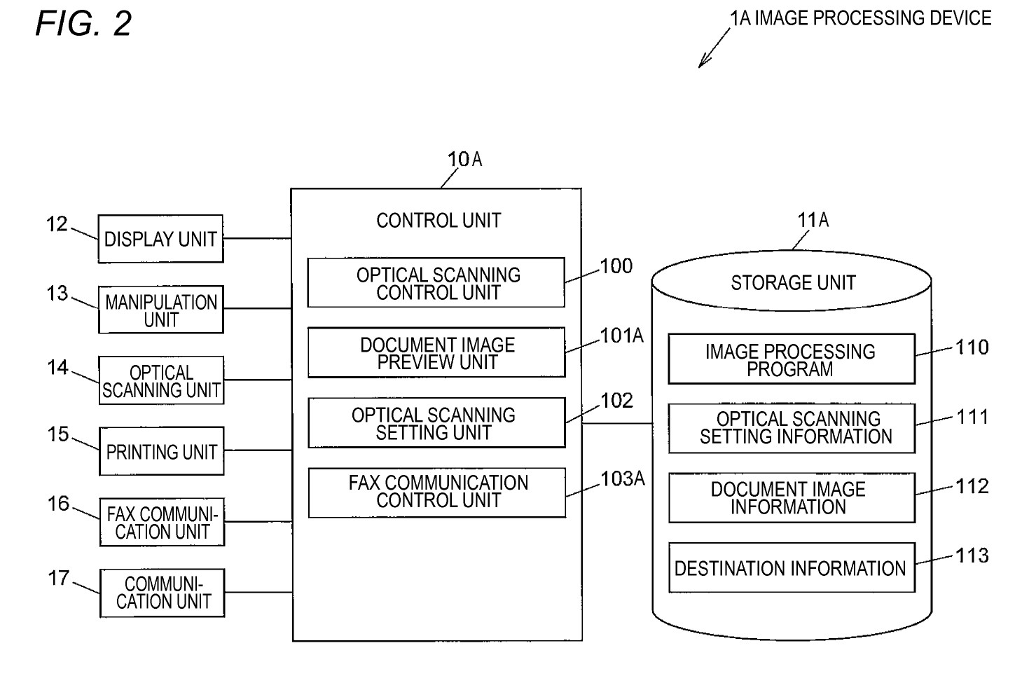

FIG. 2 is a block diagram showing a configuration example of the image processing device 1A.

The image processing device 1A includes a control unit 10A that includes a CPU and the like, controls the respective units, and executes various programs, a storage unit 11A that includes a recording medium such as a flash memory, and stores information, a display unit 12 that displays characters, images or the like, a manipulation unit 13 that manipulates the image processing device 1A, an optical scanning unit 14 that optically scans a sheet on which characters or images are written, a printing unit 15 that performs printing on the sheet, a FAX communication unit 16 that communicates with the outside via the network 5 in the FAX manner, and a communication unit 17 that communicates with the outside in, for example, a wireless manner.

The control unit 10A functions as an optical scanning control unit 100, a document image preview unit 101A, an optical scanning setting unit 102, a FAX communication control unit 103A, and the like by executing an image processing program 110 to be described below.

The optical scanning control unit 100 sets document reading conditions of the optical scanning unit 14 such as resolution, size, or color/monochrome on the basis of optical scanning setting information 111, and controls the optical scanning unit 14 in order to read the document 2.

The document image preview unit 101A generates a preview image from document image information 112 generated by reading the document 2 by the optical scanning unit 14, performs display processing on the generated preview image, and displays the processed preview image on the display unit 12.

The optical scanning setting unit 102 sets the reading condition of the document 2 of the optical scanning setting information 111 on the basis of the manipulation of a user through the manipulation unit 13.

The FAX communication control unit 103A controls the FAX communication unit 16 to transmit the document image information 112 to a destination of destination information 113 or a destination input by the user through the manipulation unit 13.

The storage unit 11A stores the image processing program 110 that operates the control unit 10A as the respective units 100 to 103, the optical scanning setting information 111, the document image information 112, and the destination information 113.

Operation of Image Processing Device

Hereinafter, the operation of the image processing device 1A of Embodiment 1 will be divided into (1) a basic operation, (2) a preview operation, and (3) a FAX transmission operation, and these operations will be described with reference to FIGS. 1 to 4.

(1) Basic Operation

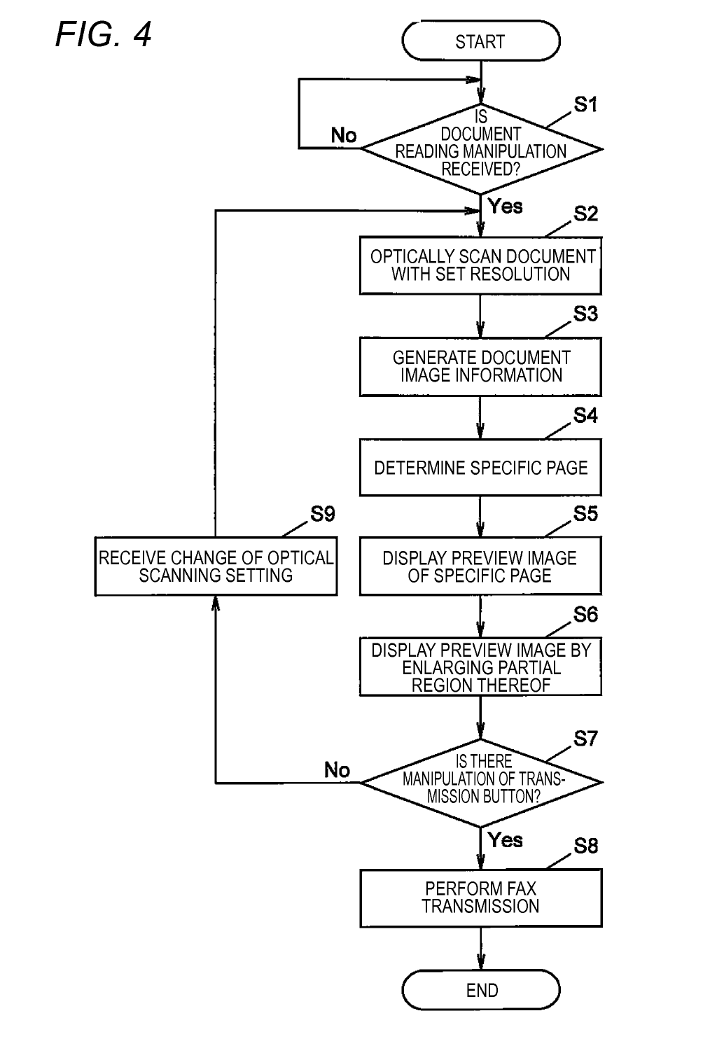

FIG. 4 is a flowchart showing an operation example of the image processing device 1A.

Initially, a user of the image processing device 1A manipulates the manipulation unit 13, and prepares for FAX reception.

The image processing device 1A starts to receive a FAX transmission request in response to the manipulation of the user (Yes in S1). The image processing device receives a telephone number of a transmission destination through selecting or inputting the number and prompts the user to set the document 2 as a target of the FAX transmission on a document stand of the optical scanning unit 14.

The user selects or inputs the telephone number of the transmission destination, sets the document 2 on the document stand, and manipulates the manipulation unit 13 in order to read the document 2 in the optical scanning unit 14.

The optical scanning control unit 100 of the image processing device 1A sets the document reading conditions such as resolution, size, or color/monochrome in the optical scanning unit 14 on the basis of the optical scanning setting information 111, and controls the optical scanning unit 14 under the aforementioned conditions to read the document 2 (S2). Here, for example, it is assumed that a resolution of 400 dpi, a size of A4, and a monochrome mode are set as default settings of the document reading conditions in the optical scanning setting information 111. The optical scanning setting information 111 may be previously set at the time of factory shipment, or may be set by the user. Alternatively, the optical scanning setting information may be set based on the obtained communication quality of the network 5.

The optical scanning unit 14 reads the document 2, generates the document image information 112, and stores the generated information in the storage unit 11A (S3).

(2) Preview Operation

Next, the document image preview unit 101A determines a specific page to be displayed among the document image information 112 generated by reading the document 2 with the optical scanning unit 14 (S4), and displays the determined page on the display unit 12 (S5). Here, the document image preview unit 101A generates, for example, a preview image of a second page of the document image information 112, and displays the generated preview page on the display unit 12. This reason for this is because a first page is inserted as a cover sheet in the FAX transmission in most cases and the cover sheet is a sheet that describes a destination or the content of a transmission document and does not include the content of the document itself. If the presence or absence of the cover sheet can be detected, when there is a cover sheet, another page other than the first page may be determined as the specific page, and when there is no cover page, the first page may be determined as the specific page.

When a predetermined page is determined as the specific page as described above, the specific page is not limited to the second page, and the last page may be used, or an arbitrary page may be selected. A plurality of predetermined pages such as even-numbered pages or odd-numbered pages may be selected as the specific pages. The predetermined page may previously set at the time of factory shipment, or may be set by the user. The predetermined page may be set when the reading of the document 2 is set.

As well as the predetermined page, a feature amount of an image such as a black-and-white change point in the case of the monochrome mode is extracted from a page on which many small-sized characters are written or a page on which an intricate image is drawn, and when the extracted feature amount exceeds a predetermined threshold value or when the extracted feature amount is greater or less than that of other pages, these pages may be automatically set as the specific page. The specific page may be determined based on a feature amount (local feature amount) of an image in a partial region on a page. For example, the local feature amount may be the present or absence of a region where character density is equal to or greater than a predetermined threshold value, or may be a result of determining similarity by calculating a vector quantity of each region. A blank page may be excluded from the specific page.

The document image preview unit 101A displays the specific page by enlarging a partial region of the specific page determined in step S4 (S6). This region is moved within the specific page through the manipulation of the user. The document image preview unit 101A may display only the enlarged partial region without displaying the entire specific page.

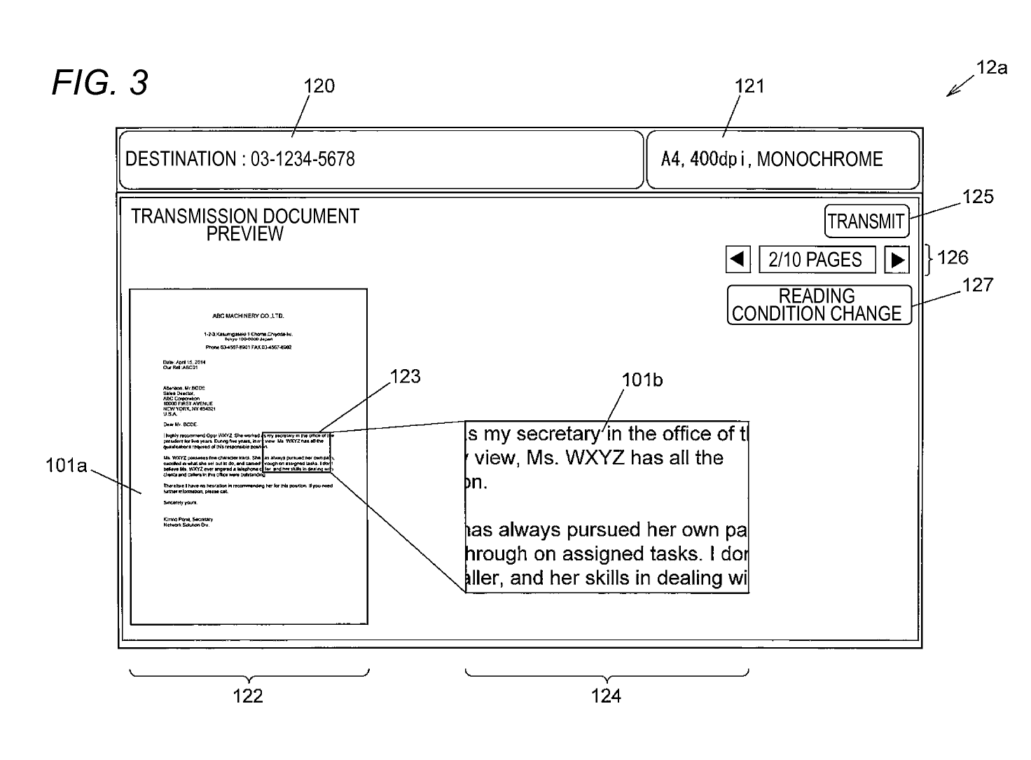

FIG. 3 is a schematic diagram showing a configuration example of a preview display screen displayed on the display unit 12 by the document image preview unit 101A.

A preview display screen 12a includes a destination 120 that displays the telephone number of a transmission destination, a setting 121 that displays the reading conditions for reading the document, a preview image display region 122 that displays a preview image 101a, an enlargement frame 123 indicating that a partial region of the preview image 101a is displayed by being enlarged, an enlargement display 124 that displays the content of the enlarged partial region, a transmission button 125 for transmitting the document image information 112 corresponding to the preview image 101a, a page change button 126 for changing another page of the document image information 112 to a preview image, and a button 127 for changing the reading conditions of the document 2.

The user checks the preview display screen 12a, manipulates the manipulation unit 13, checks the content of the document image information 112, and manipulates the transmission button 125 when there is no problem in the content of the document image information (S7).

When the user checks the preview display screen 12a and checks the content of the document image information 112 and there is a problem in the content of the document image information, the user manipulates the button 127 in order to change the reading conditions without manipulating the transmission button 125 (No in S7).

The optical scanning setting unit 102 changes the reading conditions of the document 2 of the optical scanning setting information 111 on the basis of the manipulation of the user through the manipulation unit 13 (S9). Subsequently, the image processing device 1A performs the reading of the document 2 under newly set conditions and a preview process of the document image information 112 that is newly generated.

(3) FAX Transmission Operation

Next, when receiving the manipulation of the transmission button 125 (Yes in S7), the FAX communication control unit 103A controls the FAX communication unit 16 to transmit the document image information 112 to a destination of the destination information 113 or a destination input by the user through the manipulation unit 13 (S8).

### Effects of Embodiment 1

According to Embodiment 1 described above, since the preview image of the specific page in the document image information 112 generated with the optical scanning setting information 111 is displayed on the display unit 12, it is possible to display a portion appropriate for checking the image of the read document, and thus, it is possible to reduce the effort expended when the user checks the content.

### Modification Example of Embodiment 1

The preview display screen 12a may be displayed on a display unit of the tablet terminal 3.

In this case, the user checks the preview display screen 12a, manipulates a touch panel as the manipulation unit of the tablet terminal 3, and manipulates the transmission button.

As compared to the case where the preview image is displayed on the display unit 12 of the image processing device 1A, when the preview image is displayed on the display unit of the tablet terminal 3, it is possible to more precisely display the preview image, and it is possible to perform a manipulation for selecting the preview image by using only the tablet terminal 3 without manipulating the manipulation unit 13.

### Embodiment 2

Configuration of Communication System

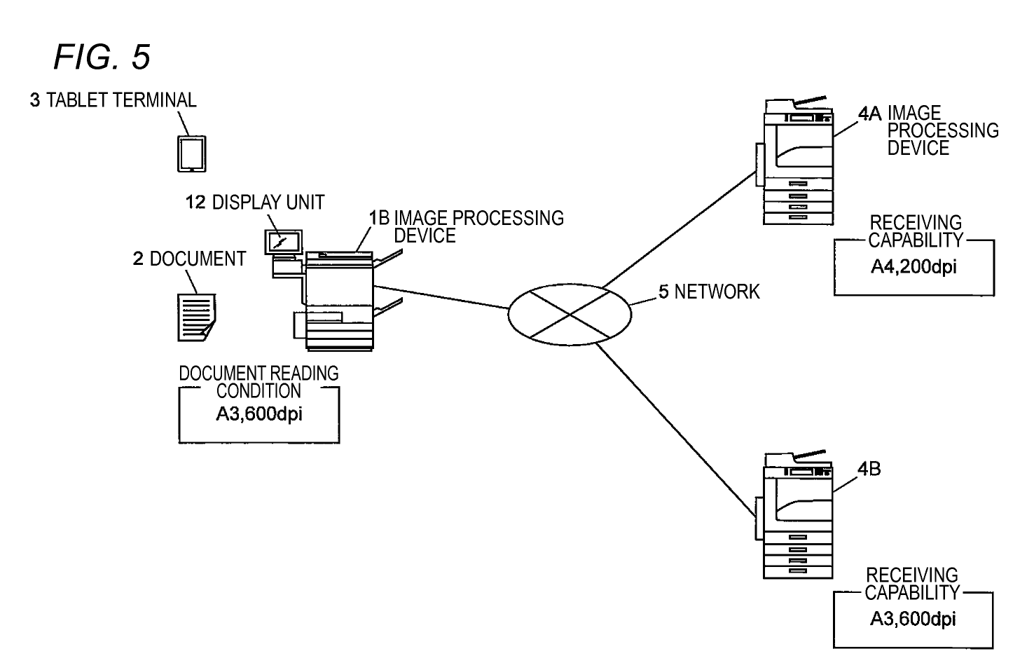

FIG. 5 is a schematic diagram showing a configuration example of a communication system according to Embodiment 2 of the present invention.

In this communication system, an image processing device 1B and external image processing devices 4A and 4B through, for example, a network 5 which is a public network are connected to so as to communicate with each other, and information is transmitted and received between the image processing device 1B and the external image processing devices 4A and 4B in, for example, a facsimile (hereinafter, referred to as a “FAX”) manner. It is assumed that the FAX receiving capability of the image processing device 4A has a maximum size of A4 and a maximum resolution of 200 dpi and the FAX receiving capability of the image processing device 4B has a maximum size of A3 and a maximum resolution of 600 dpi. The FAX may be an internet FAX or an IP-FAX.

The image processing device 1B is a device having a FAX transmission and reception function and functions of a printer, a scanner and a copier, and includes electronic components such as a central processing unit (CPU) having a function of processing information and a flash memory. The image processing device 1B reads a document 2 in an optical scanning unit 14, displays a read result on a display unit 12, and performs FAX transmission in a FAX communication unit 16. It is assumed that the reading conditions when the document 2 is read are a size of A3 and a resolution of 600 dpi.

A tablet terminal 3 communicates with the image processing device 1B in, for example, a wireless manner, and controls the image processing device 1B such that the image processing device 1B displays the read result of the document 2 read in the optical scanning unit 14 and transmits an image of the read document 2 through the FAX transmission.

The image processing devices 4A and 4B may have a FAX transmission and reception function. The image processing devices may receive information transmitted from the image processing device 1B in order to print or display the received information, and may be, for example, a dedicated facsimile machine or a printer, or a PC, a tablet terminal or a mobile phone that receives information transmitted from the image processing device 1B to display the received information.

The network 5 is, for example, a pay communication network set up by a telecommunication carrier, and is an external network such as a public switched telephone network (PSTN) or an internet protocol (IP) communication network.

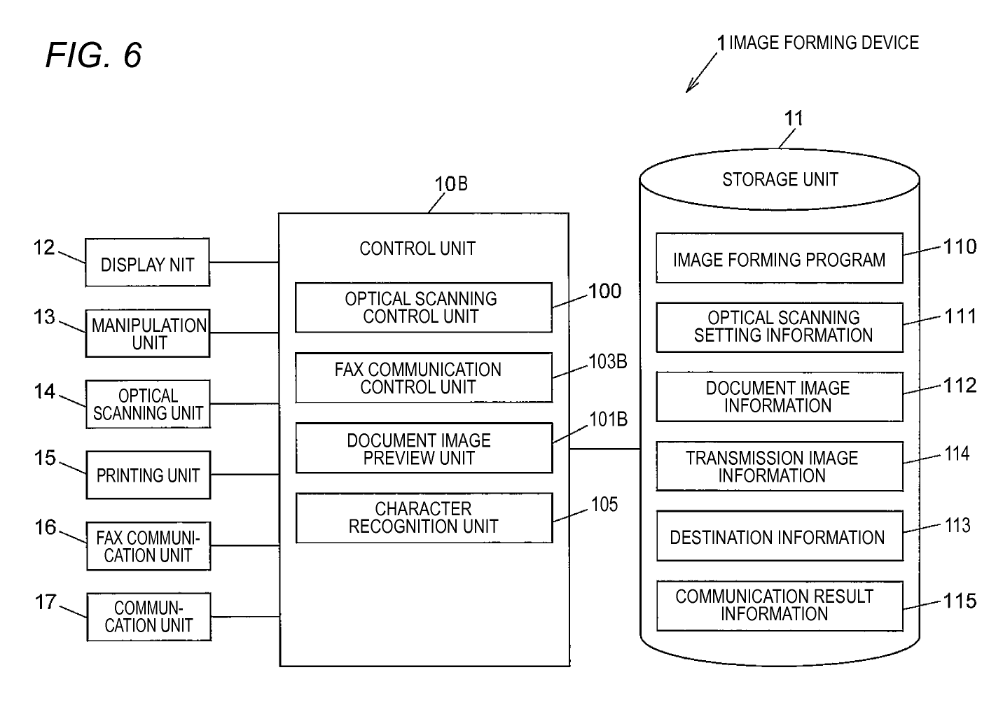

FIG. 6 is a block diagram showing a configuration example of the image processing device 1B.

The image processing device 1B includes a control unit 10B that includes a CPU or the like, controls the respective units, and executes various programs, a storage unit 11 that includes a recording medium such as a flash memory, and stores information, a display unit 12 that displays characters, images or the like, a manipulation unit 13 that manipulates the image processing device 1B, an optical scanning unit 14 that optically scans a sheet on which characters or images are written, a printing unit 15 that performs printing on the sheet, a FAX communication unit 16 that communicates with the outside via the network 5 in the FAX manner, and a communication unit 17 that communicates with the outside in, for example, a wireless manner.

The control unit 10B functions as an optical scanning control unit 100, a FAX communication control unit 103B, a document image preview unit 101B, and a character recognition unit 105 by executing an image processing program 110 to be described below.

The optical scanning control unit 100 sets document reading conditions of the optical scanning unit 14 such as resolution or size on the basis of optical scanning setting information 111, and controls the optical scanning unit 14 in order to read the document 2.

The FAX communication control unit 103B controls the FAX communication unit 16 in order to communicate the document image information 112 with a destination of destination information 113 or a destination input by the user through the manipulation unit 13, and performs capability exchange that transmits transmitting capability of the image processing device 1B and receives receiving capability of the image processing device 4A or 4B on a reception side as a destination. Specifically, the FAX communication control unit receives receiving capability through NSF and DIS based on ITU-T recommendation and T.30 recommendation.

The FAX communication control unit 103B generates transmission image information 114 from the document image information 112 by adjusting the resolution or the size of the receiving capability of a receiver. The FAX communication control unit 103B transmits the transmission image information 114, and stores a communication result as the communication result information 115 in the storage unit 11.

The document image preview unit 101B performs display processing on the transmission image information 114 as the preview image, and displays the preview image on the display unit 12.

The character recognition unit 105 executes optical character recognition (OCR) on the transmission image information 114, performs display processing on an OCR result, and displays the OCR result on the display unit 12.

The storage unit 11 stores the image processing program 110 that operates the control unit 10B as the respective units 100 to 103, the optical scanning setting information 111, the document image information 112, the transmission image information 114, the destination information 113, and the communication result information 115.

Operation of Image Processing Device

Hereinafter, the operation of the image processing device 1B of Embodiment 2 will be divided into (1) a basic operation, (2) a preview operation, and (3) a FAX transmission operation, and these operations will be described with reference to FIGS. 5 to 9.

(1) Basic Operation

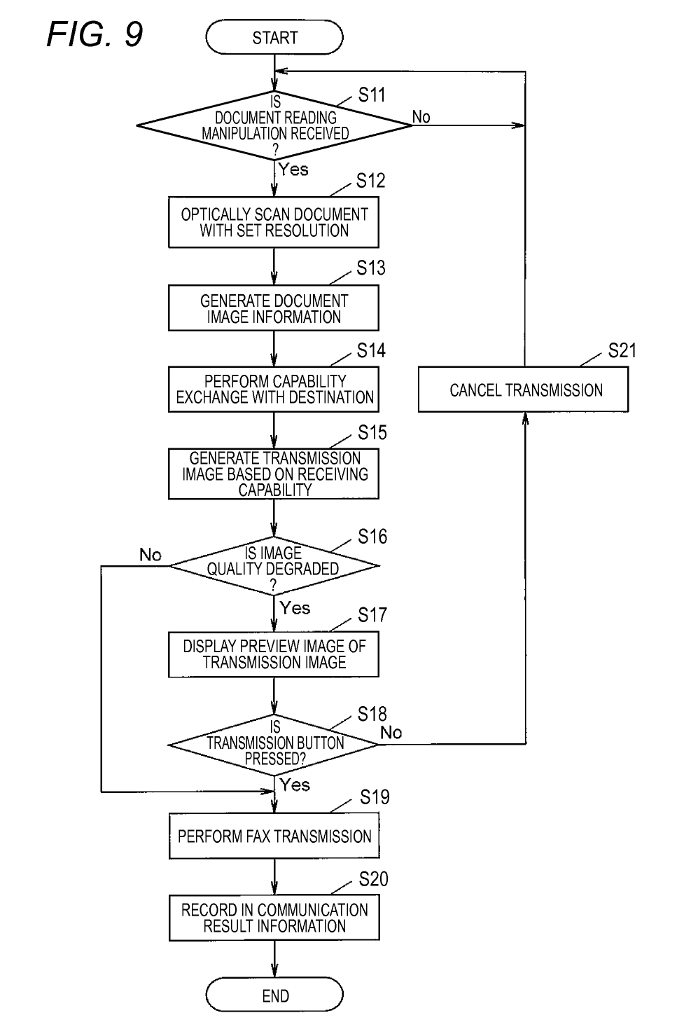

FIG. 9 is a flowchart showing an operation example of the image processing device 1B.

Initially, a user of the image processing device 1B manipulates the manipulation unit 13, and prepares for FAX reception.

The image processing device 1B starts to receive a FAX transmission request in response to the manipulation of the user (Yes in S11). The image processing device receives the telephone number of a transmission destination through selecting or inputting the number and prompts the user to set the document 2 as a target of the FAX transmission on a document stand of the optical scanning unit 14.

The user selects or newly inputs the telephone number of the transmission destination from the destination information 113, sets the document 2 on the document stand, and manipulates the manipulation unit 13 in order to read the document 2 in the optical scanning unit 14.

The optical scanning control unit 100 of the image processing device 1B sets the document reading conditions such as resolution or size in the optical scanning unit 14 on the basis of the optical scanning setting information 111, and controls the optical scanning unit 14 under the aforementioned conditions in order to read the document 2 (S12). Here, for example, it is assumed that a size of A3 and a resolution of 600 dpi are set as the document reading conditions in the optical scanning setting information 111. The optical scanning setting information 111 may be previously set at the time of factory shipment, or may be set by the user.

The optical scanning unit 14 reads the document 2, generates the document image information 112, and stores the generated information in the storage unit 11 (S13).

Next, the FAX communication control unit 103B controls the FAX communication unit 16 in order to communicate with the image processing device 4A or 4B of a destination of the selected destination information 113 or a destination input by the user through the manipulation unit 13, and performs capability exchange that transmits transmitting capability of the image processing device 1B and receives receiving capability of the image processing device 4A or 4B on the reception side as a destination (S14). Here, when the destination is the image processing device 4A, a maximum size of A4 and a maximum resolution of 200 dpi are received as receiving capability, and when the destination is the image processing device 4B, a maximum size of A3 and a maximum resolution of 600 dpi are received as receiving capability.

Next, the FAX communication control unit 103B generates the transmission image information 114 from the document image information 112 by adjusting resolution and size of the receiving capability of the receiver (S15). Here, when the destination is the image processing device 4A, the transmission image information 114 in which the size is set to A4 and the resolution is set to 200 dpi is generated, and when the destination is the image processing device 4B, the transmission image information 114 having the same quality as that of the document image information 112 is generated.

(2) Preview Operation

Next, as in the case where the destination is the image processing device 4A, when the quality of the image of the transmission image information 114 is poorer than that of the document image information 112 (Yes in S16), specifically, when the amount of data in the transmission image information 114 is smaller than that in the document image information 112, the document image preview unit 101B displays the preview image of the transmission image information 114 on the display unit 12 (S17). As in the case where the destination is the image processing device 4B, when the quality of the image of the transmission image information 114 is not poorer than that of the document image information 112 (No in S16), specifically, when the amount of data in the transmission image information 114 is not smaller than that in the document image information 112, the document image preview unit 101B forwards the process to step S19 without displaying the preview image on the display unit 12.

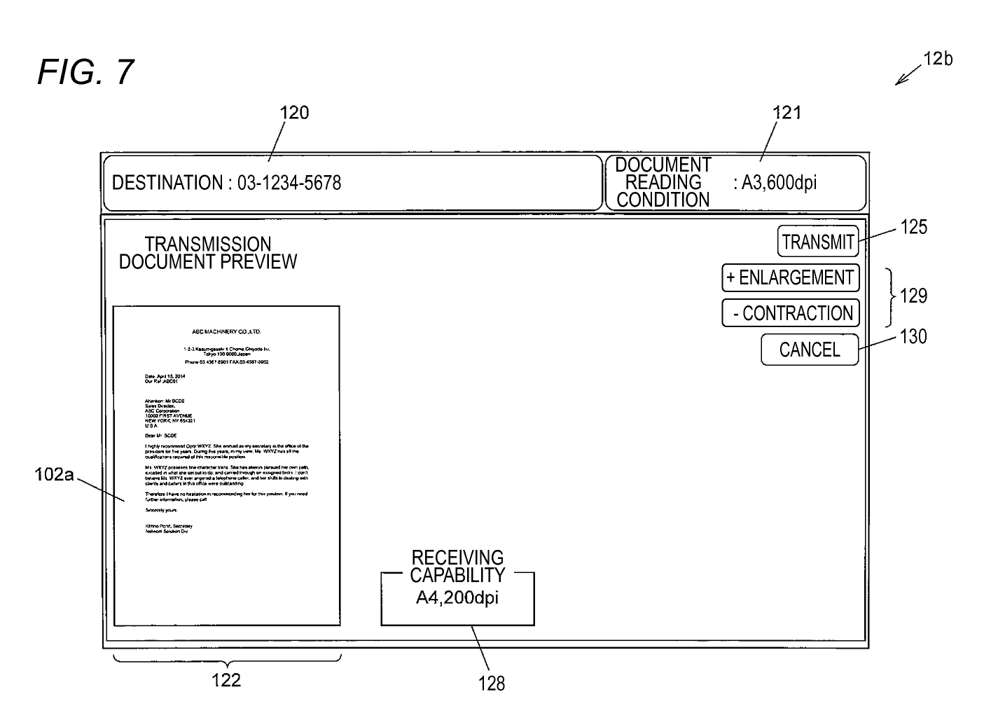

FIG. 7 is a schematic diagram showing a configuration example of a preview display screen displayed on the display unit 12 by the document image preview unit 101B.

The preview display screen 12b includes a destination 120 that displays the telephone number of a transmission destination, a setting 121 that displays the document reading conditions, a preview image display region 122 that displays the preview image 102a, a receiving capability 128 that displays the receiving capability of the destination, a transmission button 125 for transmitting the transmission image information 114, an enlarging and contracting button 129 for enlarging or contracting the display of the preview image 102a, and a cancel button 130 that stops the transmission.

The user checks the preview display screen 12b, manipulates the manipulation unit 13, checks the content of the preview image 102a while enlarging or contracting the preview image, and manipulates the transmission button 125 when there is no problem in the content of the preview image (Yes in S 18). When the user feels that it is hard to read characters or images, the user presses the cancel button 130 (No in S18). When the cancel button 130 is pressed, this process returns to step S11, and this process is repeated. However, in this case, it is possible to respond to various printing conditions. For example, the document 2 itself may be changed by the user, or the reading conditions of the document 2 may be changed. Alternatively, the document image information 112 read at a size of A3 may be generated as the transmission image information 114 in which two images having a size of A4 are set, and the preview image may be displayed again.

(3) FAX Transmission Operation

Next, when the transmission button 125 is pressed in step S18 described above (Yes in S18), the FAX communication control unit 103B transmits the transmission image information 114 to the image processing device 4A which is the destination (S19), and appends the intended determination that the image is degraded to the communication result information 115 together with the an item of a typical communication result (S20). Similarly, as in the case where the destination is the image processing device 4B in step S16 described above, when the quality of the image of the transmission image information 114 is not poorer than that of the document image information 112 (No in S16), the transmission image information 114 is transmitted to the image processing device 4A which is the destination (S19).

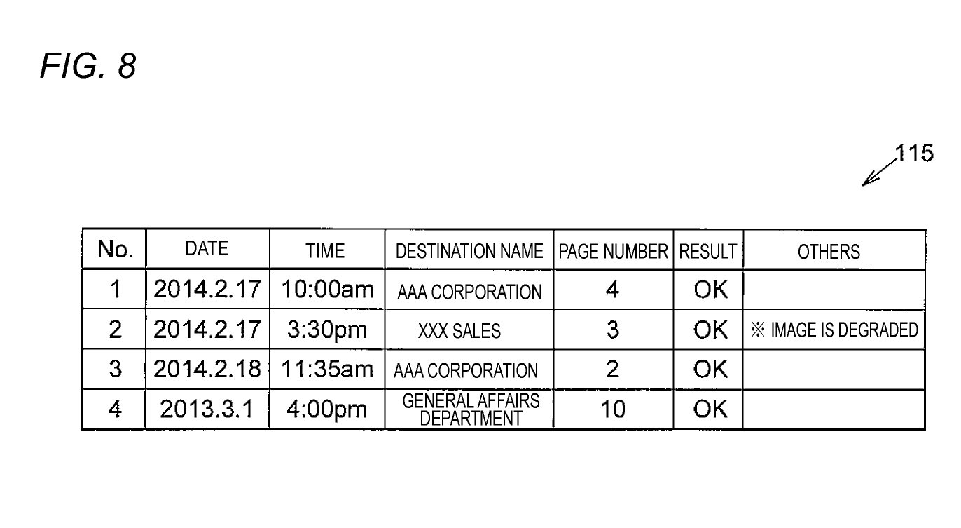

FIG. 8 is a schematic diagram showing an example of the configuration of the communication result information 115.

The communication result information 115 includes a number for identifying the communication result, a date when the communication was performed, a time when the communication was performed, a destination name indicating the name of the destination, the number of pages of the transmission image information 114, a result indicating whether or not the communication succeeded, and the other item indicating whether or not the image is degraded.

In step S20 described above, the FAX communication control unit 103B describes “* image is degraded” in the other item of the communication result information 115 when the image is degraded, and describes information in only an item of the typical communication result when the image is not degraded.

### Effects and Advantages of Embodiment 2

According to Embodiment 2 described above, the document image information 112 is generated under the reading conditions based on the optical scanning setting information 111, and the transmission image information 114 adjusted to the receiving capability of the destination is generated from the document image information 112. When the image is degraded, the preview image is displayed on the display unit 12, and the displayed preview image is checked by the user. Accordingly, the user can check the output state on a side of the receiver of the read document 2.

### Modification Example of Embodiment 2

The content of the transmission image information 114 may be recognized by the character recognition unit 105.

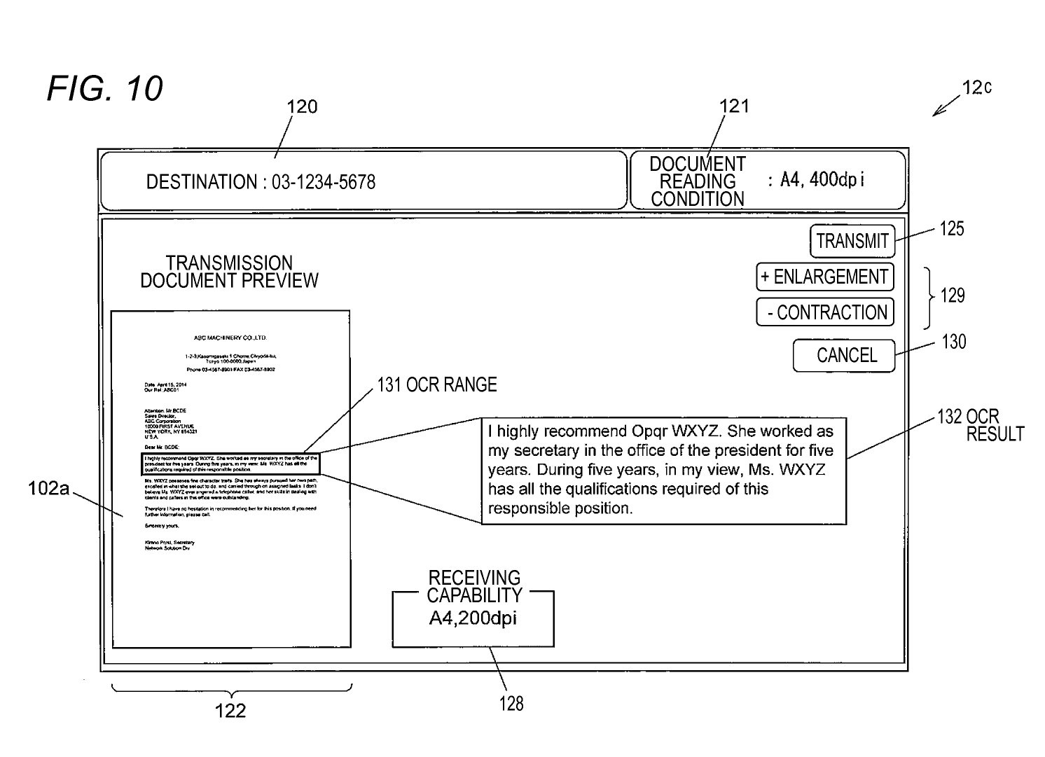

FIG. 10 is a schematic diagram showing another example of the configuration of the preview display screen displayed on the display unit 12 by the document image preview unit 101B.

A preview display screen 12c includes an OCR range 131 indicating a range recognized by the character recognition unit 105, and an OCR result 132 indicating a result recognized as characters by the character recognition unit 105, in addition to the destination 120, the setting 121, the preview image display region 122, the receiving capability 128, the transmission button 125, the enlarging and contracting button 129 and the cancel button 130.

The user checks the preview display screen 12c, and checks whether or not the content of the OCR result 132 matches the actual content of the document 2. When it is determined that the contents match each other, the user manipulates the manipulation unit 13 and presses the transmission button 125. When it is determined that the contents do not match each other, the user presses the cancel button 130.

The preview display screens 12b and 12c may be displayed on the display unit of the tablet terminal 3.

The user checks the preview display screen of the tablet terminal 3, manipulates the touch panel as the manipulation unit of the tablet terminal 3, and manipulates in the same manner as that in the aforementioned description.

As compared to the case where the preview image is displayed on the display unit 12 of the image processing device 1B, it is possible to more precisely display the preview image by displaying the preview image on the display unit of the tablet terminal 3, and it is possible to perform a manipulation that selects the preview image by using only the tablet terminal 3 without manipulating the manipulation unit 13.

Although it has been described that a single preview image is displayed on the preview display screens 12b and 12c, plural preview images may be displayed in a list.

When the amount of data in the transmission image information 114 is smaller than that in the document image information 112, the FAX communication control unit 103B may display the communication result information 115 without displaying the preview display screen, may display a warning without displaying the preview display screen, or may provide a voice, light or vibration to the user.

### Another Embodiment

Although it has been described in Embodiment 1 and Embodiment 2 that the FAX transmission is performed, the present invention is also applicable to a case where an image is copied or a case where an image is attached to an email as long as image information generated through optical scanning is used.

The image processing program 110 can be provided by being stored in a recording medium such as a CD-ROM, and may be downloaded in a storage unit within the device from a server device connected to a network such as the Internet. Some or all of the respective units 100 to 103 (105) may be implemented by hardware such as ASIC. The order of respective steps mentioned in the description of the operations of Embodiment 1 and Embodiment 2 can be changed, some steps thereof can be omitted, or other steps can be added to the aforementioned steps.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process for image processing, the process comprising:
displaying in a preview manner a specific page on a basis of a feature amount of an image of each page of document image information generated by optically scanning a document with an optical scanning unit.

2. The non-transitory computer readable medium according to claim 1,
wherein the specific page is displayed by enlarging a partial region of the specific page.

3. The non-transitory computer readable medium according to claim 1,
wherein a page other than a first page is set as the specific page.

4. The non-transitory computer readable medium according to claim 1,
wherein a predetermined page is set as the specific page.

5. The non-transitory computer readable medium according to claim 1,
wherein a change point of an image of each page of the document image information is extracted as the feature amount.

6. An image processing device comprising:
a preview unit that displays a specific page on a basis of a feature amount of an image of each page of document image information generated by optically scanning a document with an optical scanning unit.

7. A non-transitory computer readable medium storing a program causing a computer to execute a process for image processing, the process comprising:
receiving information indicating receiving capability by communicating with a reception side through a facsimile function;
generating transmission image information in accordance with the receiving capability from document image information generated by optically scanning a document with an optical scanning unit; and
displaying in a preview manner a content of the transmission image information.

8. The non-transitory computer readable medium according to claim 7,
wherein the content of the transmission image information is displayed in response to an amount of data in the transmission image information being smaller than that in the document image information.

9. The non-transitory computer readable medium according to claim 7,
wherein the transmission image information is transmitted to the reception side in response to an amount of data in the transmission image information being not smaller than that in the document image information.

10. The non-transitory computer readable medium according to claim 7, further comprising:
recognizing the transmission image information as characters,
wherein a recognition result of the recognizing is displayed together with the content of the transmission image information.

11. An image processing device comprising:
a communication control unit that receives information indicating receiving capability by communicating with a reception side through a facsimile function, and generates transmission image information in accordance with the receiving capability from document image information generated by optically scanning a document with an optical scanning unit; and
a preview unit that displays a content of the transmission image information.
